(19) United States
(12) Patent Application Publication
(10) Pub. No.: US 2013/0291657 A1
(43) Pub. Date: Nov. 7, 2013

(54) APPARATUS AND METHOD FOR NON CONTACT SENSING OF FORCES AND MOTION ON ROTATING SHAFT

(71) Applicants: Ashish S. Purekar, Silver Spring, MD (US); Jin-Hyeong Yoo, Germantown, MD (US); Alison Behre Flatau, Potomac, MD (US)

(72) Inventors: Ashish S. Purekar, Silver Spring, MD (US); Jin-Hyeong Yoo, Germantown, MD (US); Alison Behre Flatau, Potomac, MD (US)

(21) Appl. No.: 13/855,248

(22) Filed: Apr. 2, 2013

Related U.S. Application Data
(60) Provisional application No. 61/619,141, filed on Apr. 2, 2012.

(51) Int. Cl. G01L 3/10

(52) U.S. Cl. CPC G01L 3/101
USPC 73/862.333

(57) ABSTRACT

A sensor system for analysis of forces and motions on a rotating shaft using non-contact magneto-elastic sensors with the ability to measure any one or more of the following parameters of the shaft: (1) torque, (2) rate of change of torque, (3) shaft speed, (4) shaft position, (5) bending moments in the shaft in 2 directions, (6) axial force, (7) shaft power and/or system efficiency. The sensor system generally includes a magneto-elastic sensor patches fixedly applied to the rotating shaft, and a magnetic field pick up surrounding both said shaft and said magneto-elastic material but not in contact therewith, said magnetic field pick up comprising a clam-shell toroidal collar incorporating a combination of a magnetic field sensors.

### CROSS-REFERENCE TO RELATED APPLICATION(S)

The present application derives priority from U.S. Provisional Patent Application No. 61/619,141 filed 2 Apr. 2012.

### BACKGROUND OF THE INVENTION

1. Field of the Invention

The present invention relates to sensor systems and, more particularly, to a system for monitoring loads on rotating components such as shafts in pumps, compressors, motors, turbines, rotor systems, and drive trains which rely on rotating shafts to transmit power. Applications of this sensor system include Condition Based Maintenance, online performance monitoring, and loads measurement.

2. Description of the Background

Condition Based Maintenance (CBM) systems are being actively pursued for a variety of applications for machinery. The goal of a CBM system is to replace parts on an as-needed basis, which differs from conventional maintenance activities in which parts are replaced on a fixed schedule based on estimates from profile loads during design and an understanding of the failure life of structural components.

The schematic in FIG. 1 is a graphical illustration showing how the lifetime of a part can be extended beyond that used in conventional practice. The traditional approach is based on a model with an assumed usage level for the component. Actual use of the machinery component which does not fall into the assumed usage levels would result in scheduling of maintenance before it is required or after the part has unacceptable levels of damage. Parts which do not need to be replaced are changed out for newer parts unnecessarily and/or critically damaged parts may stay in service until the next inspection. Both represent significant inefficiencies in conventional maintenance practices. These inefficiencies result in unnecessary maintenance actions which increases the total operating cost.

For example, the use of CBM technologies is of importance for military and civilian systems as means of improving operating efficiency. One area of application is the ability to track machinery components such as pumps, compressors, and motors which rely on rotating shafts to transmit power. Common damage types include shaft degradation, shaft coupling misalignment, and bearing wear and failure. For example, if a critically damaged part passes an inspection and fails in the field the vessel will need to be docked for an unwanted teardown to inspect hidden parts. The ability to track static and dynamic torque levels on the shaft would provide a key ingredient in the CBM approach for machinery.

Conventional torque measurement systems rely on transducers mounted to the rotating shaft which transmit information through a slip ring into the fixed frame. This approach poses challenges in the CBM context for at least two reasons: 1) brushed slip rings have defined life spans; and 2) retrofit applications are limited as slip rings need to fit over the shaft causing disassembly of the machine.

Consequently, there is a need for a novel method of measuring torque levels which eliminates the integration and life span challenges associated with slip rings. Such a system would be a major improvement to health monitoring systems for machinery components.

### SUMMARY OF THE INVENTION

It is, therefore, an object of the present invention to provide a non-contact method and apparatus for torque sensing of a rotating shaft.

It is another object to provide a sensor system incorporating the above with the ability to measure any one or more of the following parameters of the shaft: (1) torque, (2) rate of change of torque, (3) shaft speed, (4) shaft position, (5) transverse bending moments in the shaft in 2 directions, (6) axial load, (7) shaft power and/or system efficiency (from combinations of the foregoing measurements).

### BRIEF DESCRIPTION OF THE DRAWINGS

Other objects, features, and advantages of the present invention become more apparent from the following detailed description of the preferred embodiments and certain modifications thereof when taken together with the accompanying drawings in which:

FIG. 1 is a graphical illustration showing how the lifetime of a part can be extended beyond that used in conventional practice.

FIG. 2 is a perspective view of an exemplary NCTS 10 installed on a rotating shaft 20. The NCTS consists of a magnetoelastic material 30 fixed to the rotating shaft 20 and a sensor system 40 in the non-rotating (or fixed) frame.

FIG. 3 is a block diagram of the Sensor System 2 for signal analysis and processing.

FIG. 4 (left) is a schematic depicting rotation of magnetic moments due to stress in a magnetoelastic material, and 4 (right) is a graph showing change in magnetic induction with compressive stress under constant H field in a magnetoelastic material.

FIG. 5 (A) shows an experimental setup implemented with a cantilevered aluminum beam, and FIGS. 5(B-E) show the graphical results.

FIG. 6 illustrates a static test setup using polyvinyl chloride pipe as the test article, including (A) Schematic layout; (B) Sensor orientation; and (C) Characterization results.

FIG. 7 illustrates follow-up testing using a metal shaft, including a photo of the test setup in FIG. 7(A); (B) Hall effect sensor position, and (C) Bias magnet positions.

FIG. 8 show the data derived from the test setup of FIG. 7, including (A): Hall sensor position 1; (B): Hall sensor position 2; (C): Hall effect sensor at position 3.

FIG. 9 shows a test setup, (A) being a photo, (B) a sketch, and (C) the graphical results.

FIG. 10 is a composite graph of the averaged peak output for the Hall effect sensor.

FIG. 11 illustrates magnetic field pick up 40 closely surrounding both shaft 20 and magneto-elastic sensor 30, but not in contact therewith.

FIG. 12 is schematic of the annealing process.

FIG. 13 is a diagram of the deposited magnetic layer for imparting a magnetizing field.

FIG. 14 illustrates an exemplary programmable controller board layout implementing the block diagram of FIG. 3

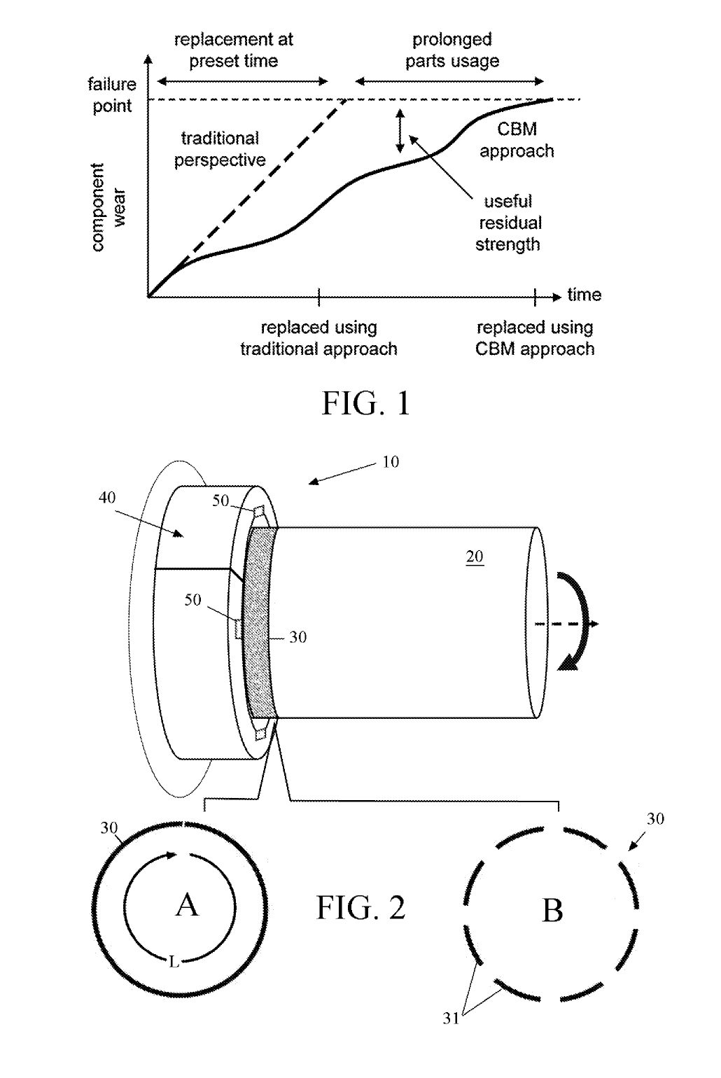

### DETAILED DESCRIPTION OF THE PREFERRED EMBODIMENT

The present invention is a non-contact torque sensor for rotating shafts, and a wireless sensor system for tracking torque levels on a rotating shaft. The system includes a combination of hardware and software components which serve to provide structural state awareness useful for CBM. The non-contact torque sensor is based on “magnetoelastic” material and non-contact magnetic field sensors. The software components convert the raw sensor signal into torsional moment information on the rotating shaft. “Magnetostriction” is defined as a property of ferromagnetic materials that causes them to change their shape when subjected to a magnetic field. Similarly, “magnetoelastic” or “elastomagnetic” materials change dimensions when exposed to a magnetic field. The reverse effect allows for strain and/or shape sensing of mechanical deformations. Since magnetoelastic or elastomagnetic materials are also magnetostrictive, for purposes herein reference to magnetoelastic, elastomagnetic or magnetostrictive material encompasses any suitable material in which a strain causes a magnetic field or flux capable of being sensed. A wireless sensor system is also disclosed that employs a network of non-contact torque sensors arranged in nodes. The nodes communicate with each other and report back to a central host. Each node is composed of a set of sensors, data acquisition subsystem, communications package, and power conditioning. The nodes monitor various components of the vehicle, report back to a host system, which then consolidates the information from the various nodes and performs diagnostics and prognostics. The hardware and software components are described on detail below.

The Non-Contact Torque Sensor (NCTS)

FIG. 2 is a perspective view of an exemplary NCTS sensor 10 installed on a rotating shaft 20. In contrast to conventional slip ring torque sensors which require electrical circuits in which brushes mounted on the shaft maintain electrical contact with the slip rings, the NCTS sensor 10 relies on magneto-elastic effect, e.g., the interaction between the magnetization and the strain of a magnetic material. There is no mechanical contact. This is accomplished with a magneto-elastic material 30 applied to the rotating shaft 20, and a magnetic field pick up 40 closely surrounding both shaft 20 and magneto-elastic sensor 30, but not in contact therewith. The magneto-elastic sensor 30 may be one or more patches of magneto-elastic material adhered, bonded, or electrochemically deposited to the shaft 20. Any suitable magneto-elastic material may suffice including materials like iron or nickel which have very low magneto-elastic coupling, or more advanced materials with improved magneto-elastic properties including Terfenol-D™, Metglas™, and Galfenol™. Terfenol-D™ exhibits brittleness and low tensile strength restricting its use as a robust sensor. In the preferred embodiment, the magneto-elastic sensor 30 comprises a 360 degree annular patch of Galfenol, an alloy of iron and gallium. Galfenol exhibits a good combination of high sensitivity and attractive elastic properties, and is capable of measurement of axial, bending and torsion in substructures. Galfenol exhibits very low magnetic hysteresis and low temperature dependence of its magneto-elastic properties thus reducing any error in sensing measurements due to magneto-mechanical transduction and thermal fluctuations. Galfenol exhibits a high Curie temperature which ensures that it can be operated at elevated temperatures. The Galfenol Curie temperature is significantly higher than other magneto-elastic materials resulting in an expected operational range of temperatures between −50° F. to 300° F., which provides a higher thermal tolerance. In addition, Galfenol is ductile, machinable and weldable and hence can be easily deployed as a sensor patch either bonded or thermally joined to host shaft 20. Galfenol also has good corrosion resistance and low raw material cost, making it a reliable and inexpensive sensing material capable of operating under harsh conditions. Thus, use of Galfenol as the magneto-elastic component provides an optimum combination of low cost, small size, high sensitivity, and stable thermal properties for wide range of temperatures.

The magneto-elastic sensor 30 is preferably an elongate rectangular patch applied to and circumscribing the rotating shaft 20 as shown at (A) in FIG. 2, with length L equal to π×2×the radius of the shaft. Alternatively, magneto-elastic sensor 30 may comprise a plurality of smaller rectangular patches 31 equally-radially spaced around the shaft 20 as shown at (B). Either way, the sensor 30 is designed to measure the torsion strain in the rotating shaft 20. The Galfenol patch(es) are rigidly attached (by welding or the like) or bonded (by adhesive or the like) to the shaft 20 for efficient strain transfer from the shaft 20. Preferably, a magnetic pre-bias field is provided through the magneto-elastic sensor 30 for greater strain sensitivity. This can be accomplished using one or more permanent magnets 50, biasing coils, or imparting remnant magnetization to impart a magnetic bias field. For example a magnetizing field can be introduced using discrete permanent magnet (s) 50, or by magnetic layer deposition on the Galfenol material 30. An annealing process may be used to produce a material with optimized sensing properties. Note that adding surface features (such as ridges, ribs or indentations) to the magneto-elastic sensor 30 (or rectangular patches 31) can improve sensitivity or provide additional sensing modalities, and this characteristic is considered to be within the scope and spirit of the invention. A magnetic field sensing system 40 is a split (two section) toroidal collar in which the two sections join to form a toroid having an inner radius slightly greater than that of the shaft 20, plus a combination of sensor comprising Hall effect, pickup coil, and/or Giant Magnetoresistance (GMR) sensors. The pickup coil is an arrangement of turns wound upon designated sections of the toroid or on components mounted to the toroid. Hall-effect sensors are well established. The clamshell design allows for retro-fit capable unit in which the shaft 20 may be instrumented without disassembly of machinery components. The slotted toroid both concentrates and focuses an induced magnetic field to improve sensitivity of the overall system. Alternatively, the magnetic field sensor may be any other sensor that produces an output signal in response to a magnetic field, as a matter of design choice based on based on criteria such as sensitivity, resolution and operating range. GMR sensors are known devices comprising ferromagnetic alloys sandwiched around an ultrathin nonmagnetic conducting middle layer which exhibits a large change in resistance (typically 10 to 20%) when the devices are subjected to a magnetic field. Either type of magnetic field sensor is capable of sensing a quantity relative to the torque level of the magneto-elastic sensor 30. The pickup coil arrangement determines the rate of change of the torque level. The foregoing NCTS sensor 10 installed on a rotating shaft 20 confers the ability to measure torsion as well as bending of the shaft, as well as torque rate of change. Moreover, it has the ability to measure torque on non-metallic shafts (such as composite shafts).

Wireless Sensor System

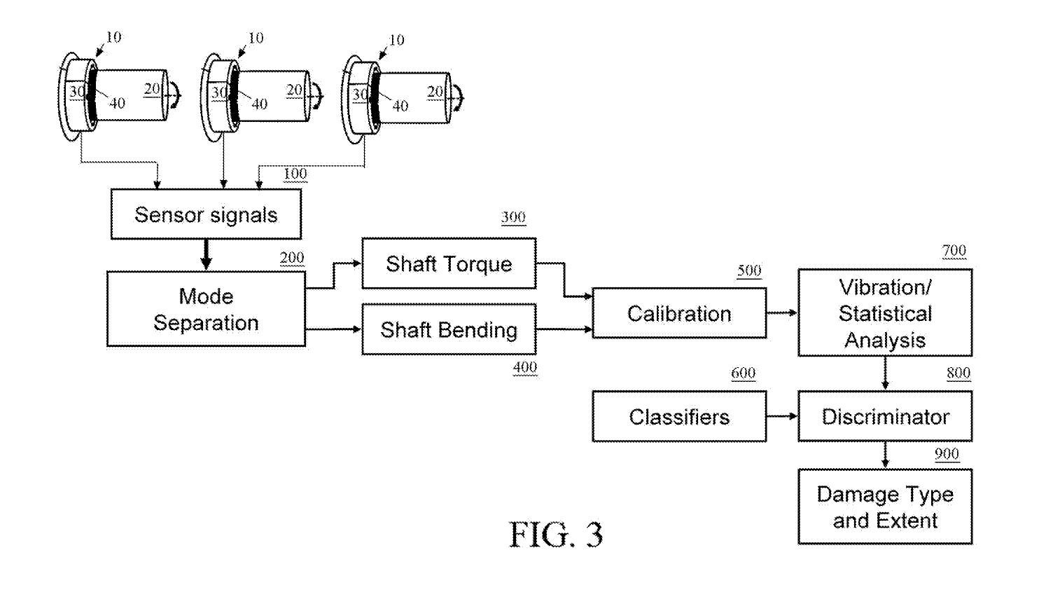

FIG. 3 is a block diagram of the Wireless Sensor System 2 for signal analysis and processing. The Wireless Sensor System 2 employs one or more NCTS sensors 10 as described above arranged in a “node.” Signals are derived from the NCTS sensor 10 installed on a rotating shaft 20 as shown in FIG. 2, and signal conditioning, amplification and/or filtering of the signals from the suite of magnetic field sensors 40 is conducted as needed. At step 100 the analog signals are converted to digital by a digital-to-analog converter suitable for data acquisition of a time series. A mode separation module 200 is deployed for separating the data into torque or bending components corresponding to shaft torque, shaft torque rate of change, and shaft bending which are all critical for condition based maintenance of machinery components. The mode separation module 200 may be a conventional host computer running modal analysis software to separate the data components. The torque components are subjected to shaft torque analysis at step 300, while bending components are subjected to bending analysis at step 400. Preferably the torque component will be a time series of torque data points, the bending component will be a time series of bending data points, and the two components will be subjected to respective time series analysis at steps 300-400. Regression analysis is the most typical time series analysis. If shaft torque is being experienced, a torque calibration is made at block 500, and if bending is being experienced, a bending calibration is made at block 500. The calibrated time series data is subjected to a vibration/statistical analysis at block 700, as described below. At block 800 the results of the vibration/statistical analysis from block 700 are compared to a library of classifier profiles 600 to discriminate a damage type and extent. The measured torque induced stress can be used to calculate the fatigue life of the shaft. The torque rate of change measurements can be used to monitor shaft coupling and bearing degradation. The bending vibration measurements can be used to monitor shaft coupling and alignment degradation. The damage type and extent are outputted at block 900.

### EXPERIMENTAL EXAMPLES

### a. Example I

Magnetostriction is a change in length undergone by ferromagnetic materials under a magnetic field. Iron elongates along the direction of magnetization and is said to have positive magnetostriction. Some materials however may contract along this direction and are said to have negative magnetostriction. The concept of magnetic dipoles is that within the material there are very small north and south magnetic poles. Magnetic domains are small regions of a material that have all of their magnetic dipoles aligned in parallel. In ferromagnetic materials, without the presence of a magnetic field or stress (demagnetized state) the domains within the material have random directions. The total magnetization outside the presence of a magnetic field therefore averages to zero. When a magnetic field is applied, the ferromagnetic crystals tend to align in a preferred crystallographic direction. These are known as the easy directions since if the magnetic field is applied in this direction it is easiest to magnetize a sample to saturation. The relationship when applying a magnetic field, H, to the magneto-elastic sensor 30 and its mechanical response is a non-linear function. This relationship between the magnetic and mechanical properties of the magneto-elastic sensor 30 can be approximated for moderate applied field or about a bias point using the linear coupled magneto-mechanical constitutive relations. These relationships for a magnetostrictive material at constant temperature are:

ε=s^{H}σ+dH

B=d*σ+μ^{σ}H

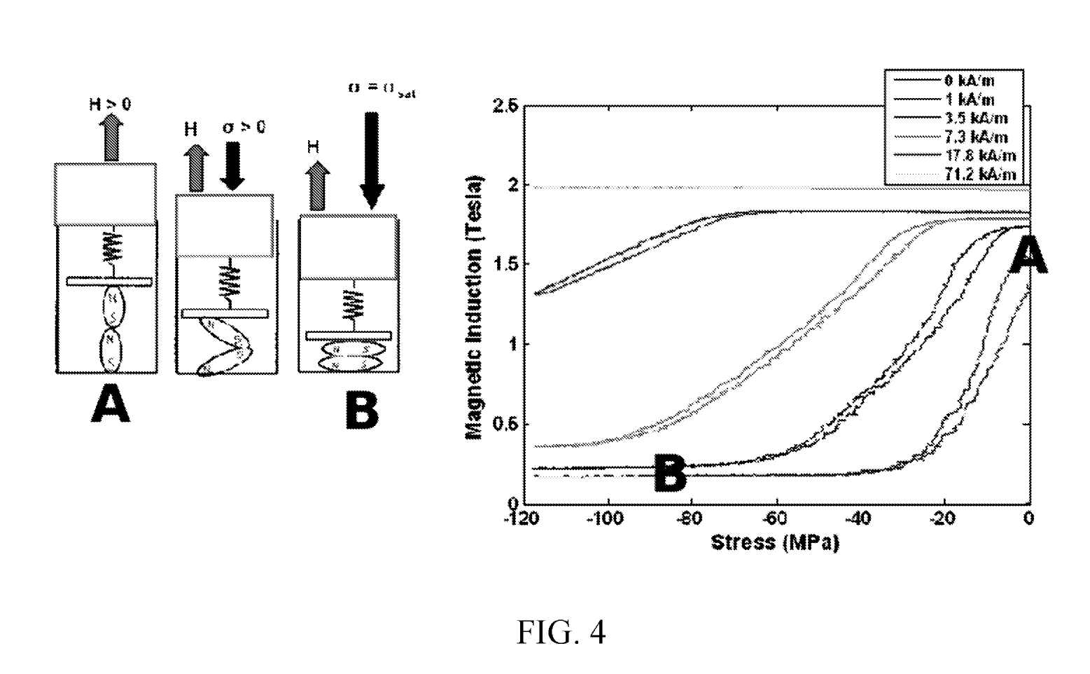

The two portions of the first equation represent the contribution of mechanical stress and magnetic field to the strain on the magneto-elastic sensor 30. The linearized function for the magnetic induction (B) in the second part can also be broken into two parts, one representing the mechanical contribution and the other representing the magnetic field contribution. Galfenol exhibits magnetostriction of approximately 350-400 ppm under magnetic field strengths of around 100 Oe (˜7.96 kA/m). Galfenol compositions can range from approximately 13%-30% Gallium, with alloys that have ˜19% Gallium exhibiting both good magnetostriction and good mechanical properties, e.g. ductility. Data showing how magnetic induction in Galfenol varies with stress in the presence of a constant applied magnetic field H in the <100> crystallographic direction are shown in FIG. 4.

FIG. 4(A) is a schematic depicting rotation of magnetic moments due to stress, and 4(B) is a graph showing change in magnetic induction with compressive stress under constant H field. Under zero stress, the sample becomes magnetized along the direction of the applied field H. As a compressive stress is applied, once the magnetic anisotropy energy is overcome the magnetic moments in the material rotate away from the applied field direction. This causes a decrease in the magnetization and length of the sample. This rotation produces a measurable change in the materials B field that is roughly linearly proportional to the applied stress over a range of stresses that is determined by the magnitude of the magnetic bias. The data in FIG. 4 can be used to determine the appropriate magnetic field bias strength to operate within the linear induction-stress region of a sample for a given range of applied stress. For detection of a large range of compressive stresses (up to approximately 60 MPa), a higher strength bias field is needed; although sensitivity, i.e. change in induction per unit stress, would decrease. Also, note that a sample would need to be pre-stressed to the stress at which the linear decrease in slope of induction versus stress starts to use the full strain potential of a sample under larger bias fields.

### b. Example 2

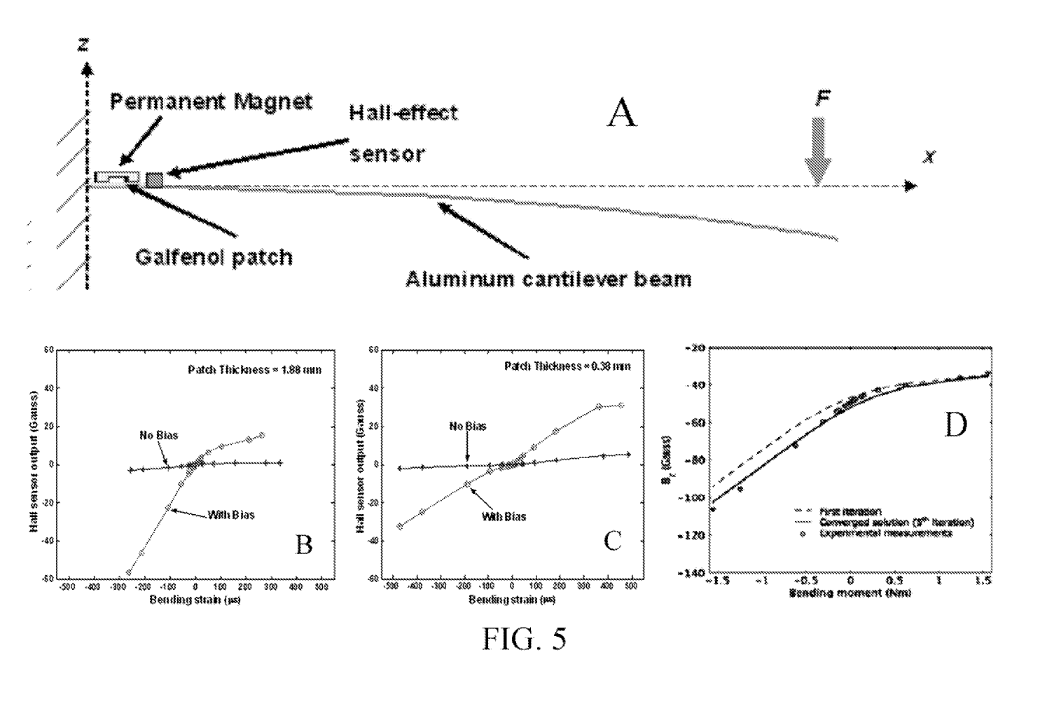

Galfenol has also been characterized as a strain sensor in bending mode. To illustrate this, FIG. 5(A) shows an experimental setup implemented with a cantilevered aluminum beam (355.6×26.1×3.2 mm³) placed in between two aluminum spacers near its root and bolted onto a load cell. The other end of the load cell is attached to a magnetic shaker. Single crystal Galfenol (Fe₈₄Ga₁₆) patches of dimensions 25.4 mm by 8.5 mm and of two different thicknesses (1.88 mm and 0.38 mm) were used. The patches had the crystallographic <100> directions oriented along their length, width and thickness. The Galfenol patch was bonded onto the beam near its root as shown in FIG. 5(A), so that it experiences the maximum bending moment when the beam is loaded at the tip. A strain gage bonded on the beam surface next to the Galfenol patch measured the strain while a Hall-effect sensor placed at one end of the patch surface was used to obtain a signal proportional to the change in magnetic induction in the patch. A C-shaped permanent magnet placed on the Galfenol patch was used to provide a magnetic bias to the patch to improve its sensing performance. The choice of magnet was restricted by the geometry of the patch and by the varieties commercially available. For static sensing characterization, dead weights between 0 to 500 grams were hung from the free end of the beam and the strain and Hall sensor output were noted for both magnetically unbiased and biased conditions of the patch. The calibration was done for both tensile and compressive regimes by taking measurements with the Galfenol patch and strain gage on the top and bottom surfaces of the beam respectively. The results shown in FIG. 5(B) indicate that a Galfenol patch worked as linear strain sensors and their performance was improved by using a magnetic biasing scheme (such as the permanent magnet in this case). A magneto-mechanically coupled 3D finite element modeling scheme was used to model the torque sensor system. This model was developed by coupling FEM models of magnetic and mechanical boundary value problems with a non-linear magneto-elastic model. The model works on an iterative algorithm which takes care of the effect of the magnetic and mechanical parameters on each other. This model has been benchmarked against the experimental results obtained from Galfenol sensor characterization in bending mode. FIG. 5(C) shows the finite element formulation of the Galfenol sensor attached to a cantilevered Aluminum beam subjected to bending loads. The result from the magneto-mechanically coupled 3D FEM model shows very good correlation with the experimental values.

### Example 3

By acting as a strain sensor, Galfenol can also act as a torque sensor under static conditions. An experimental setup was constructed with a cantilevered polyvinyl chloride shaft (762 mm long and 63.5 mm diameter) bolted at one end to provide a clamped boundary condition. A single crystal Galfenol (Fe₈₄Ga₁₆) patch of dimensions 25.4 mm×8.5 mm×1.88 mm was bonded on the shaft surface near its root as shown in a with orientation shown relative to the compressive and tensile stresses. A Hall-effect sensor placed at one end of the patch surface was used to obtain a signal proportional to the change in magnetic induction in the patch. A permanent magnet placed on the Galfenol patch was used to provide a magnetic bias to the patch to improve its sensing performance. The static torque was applied by hanging dead weights from a load arm attached to the free end of the polyvinyl chloride shaft. The result indicates that the Galfenol patch worked as a linear torque sensor. The torque sensor signal gives a measure of the stress in the shaft. This value of stress can be used for health monitoring of shafts by comparing with the yield strength of the shaft material and can also be used to calculate the remaining life of the shaft before which it can fail due to fatigue.

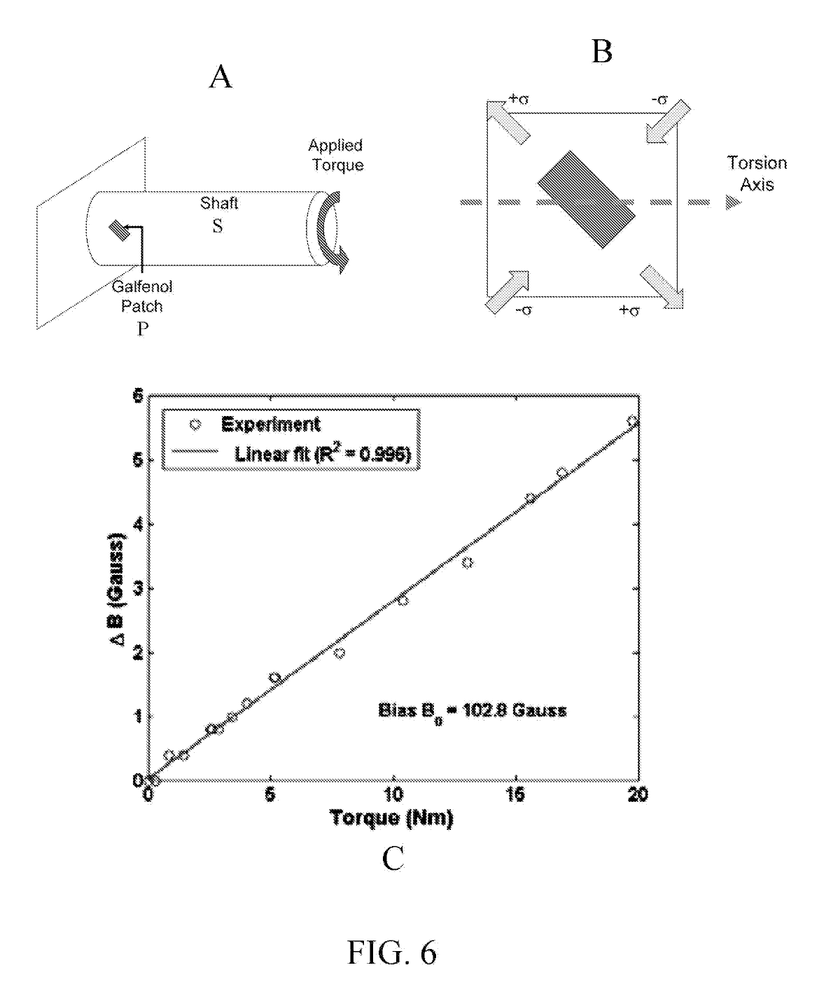

FIG. 6 illustrates a static test setup using polyvinyl chloride pipe as the test article, including (a) Schematic layout; (b) Sensor orientation; and (c) Characterization results.

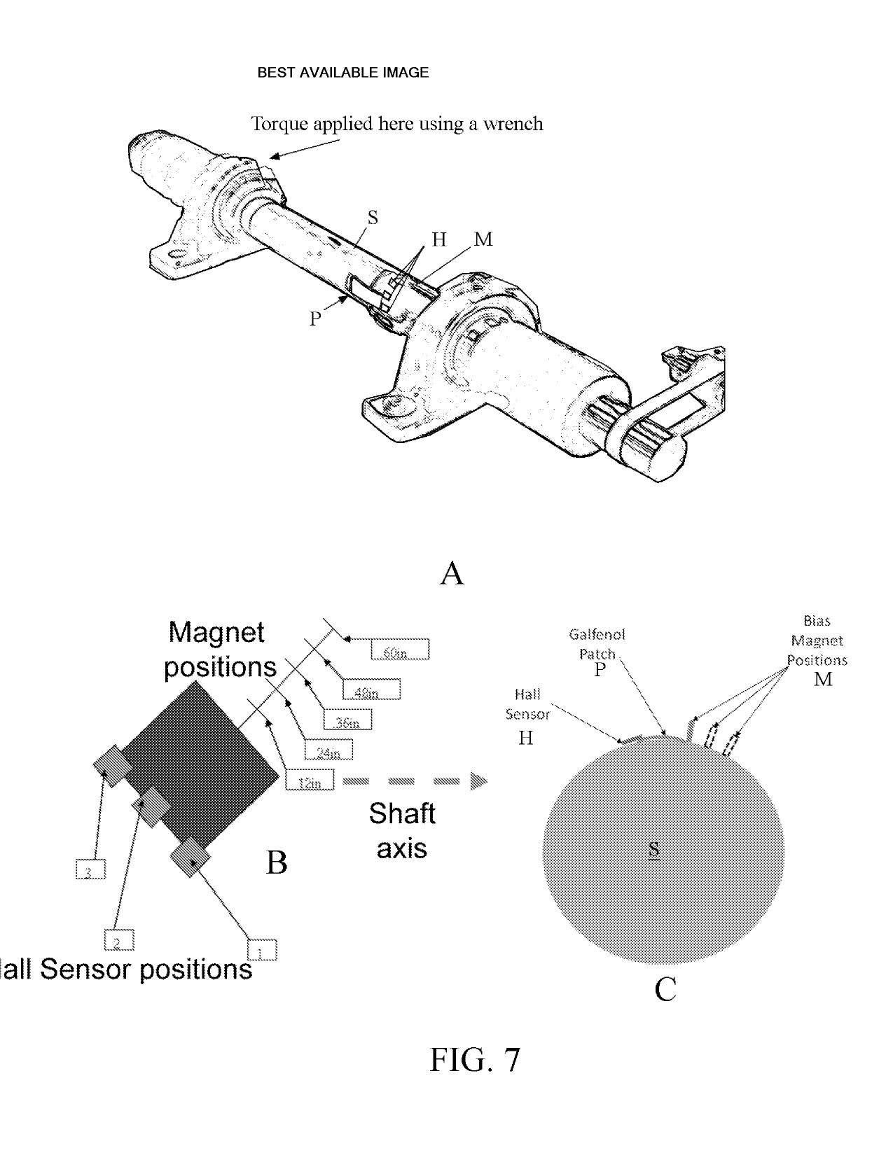

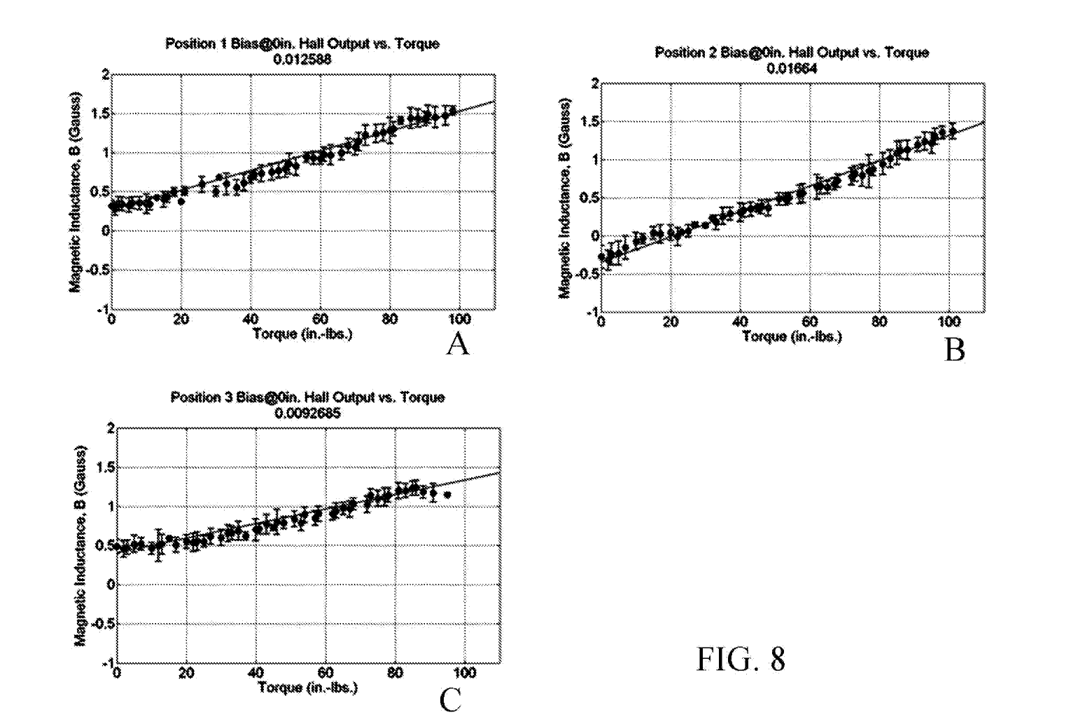

Follow-up testing was performed using a metal shaft as shown in FIG. 7, including (A) a sketch of the static test stand; (B) Hall effect sensor position, and (C) Bias magnet M positions. This test was used to evaluate the best location for a Hall sensor and the best position for the biasing neodymium permanent magnet relative to the Galfenol patch. A photo of the static test stand is given in 7(A). Coupler A is bolted to the table while torque is applied to the opposite shaft collar using a wrench. The Galfenol patch P (0.39×0.39×018 in 19 at. % Gallium) was bonded to the shaft S with <100> direction oriented parallel to the 45° direction on the shaft with respect to the shaft axis in order to take advantage of the maximum compressive and tensile stresses on the shaft surface. This will give the maximum change in magnetic field around the Galfenol patch. This procedure is repeated for the three Hall effect sensor locations, shown in FIG. 7(B), with the bias magnet mounted closest to the Galfenol patch. The torque loading procedure was then repeated as the bias magnet was moved away from the patch in increments of 0.12 inch up to 0.60 inch, as shown in FIG. 7(C). Moving the Hall effect sensor from position 1 to position 2 increased the slope of the magnetic inductance versus torque curve from 0.012568 to 0.01664 Gauss/in-lbs. These data are shown in FIG. 8 (A: Hall sensor position 1; B: Hall sensor position 2; C: Hall effect sensor at position 3). Moving to position 3 caused a decrease in slope to 0.0092665 Gauss/in-lbs, shown in 8(C). The slope can be considered as the sensitivity or response from the material measured by the Hall effect sensor. For the static case, the highest sensitivity is attained when the Hall effect sensor is placed directly across from the bias magnet in position 2. With the Hall sensor in position 1, the bias magnet was then moved away from the patch along the path indicated by FIG. 7(B). Moving the bias away from the patch for all measured distances resulted in a lower sensitivity of the patch when compared to closest separation case, as shown in the three representative graphs in FIG. 8(A-C). FIG. 8(D) shows the effect of bias magnet position on torque sensitivity with bias magnet at position 2; and (E) Bias magnet at position 3. There was however, up and down fluctuation in sensitivity between 0.12 and 0.60 inch. This is most likely due to the bias magnet being moved around the shaft and not in a single plane as seen in FIG. 7(C).

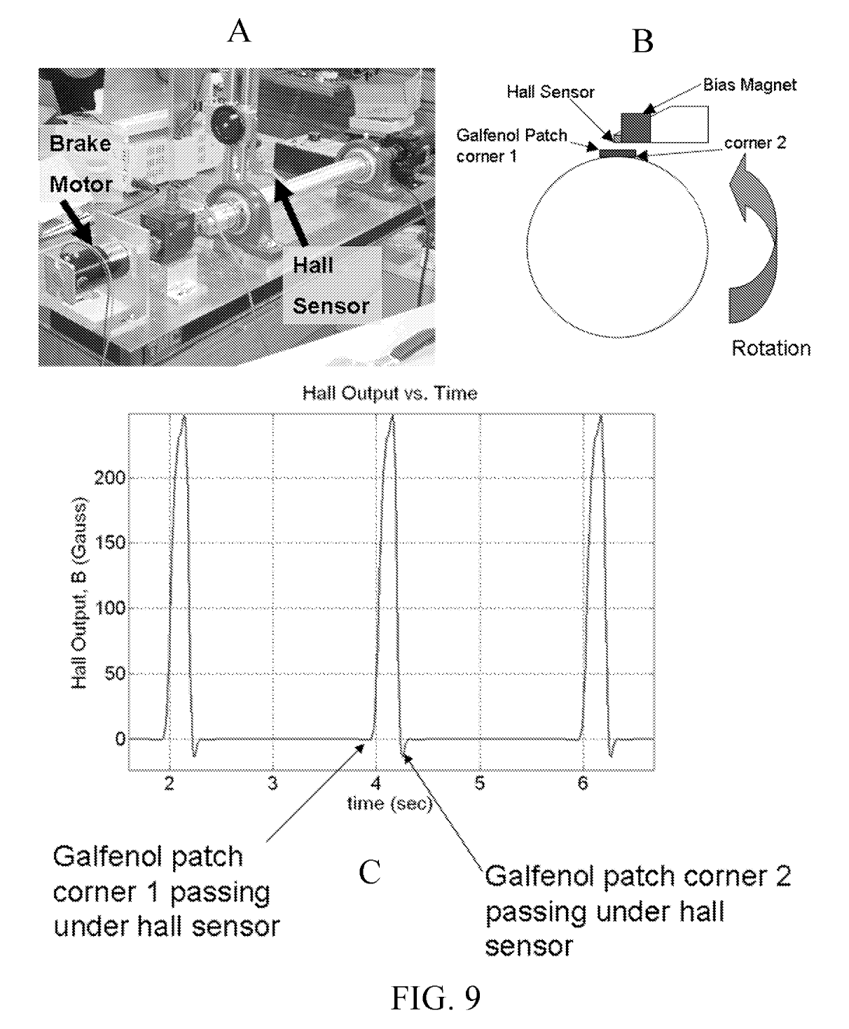

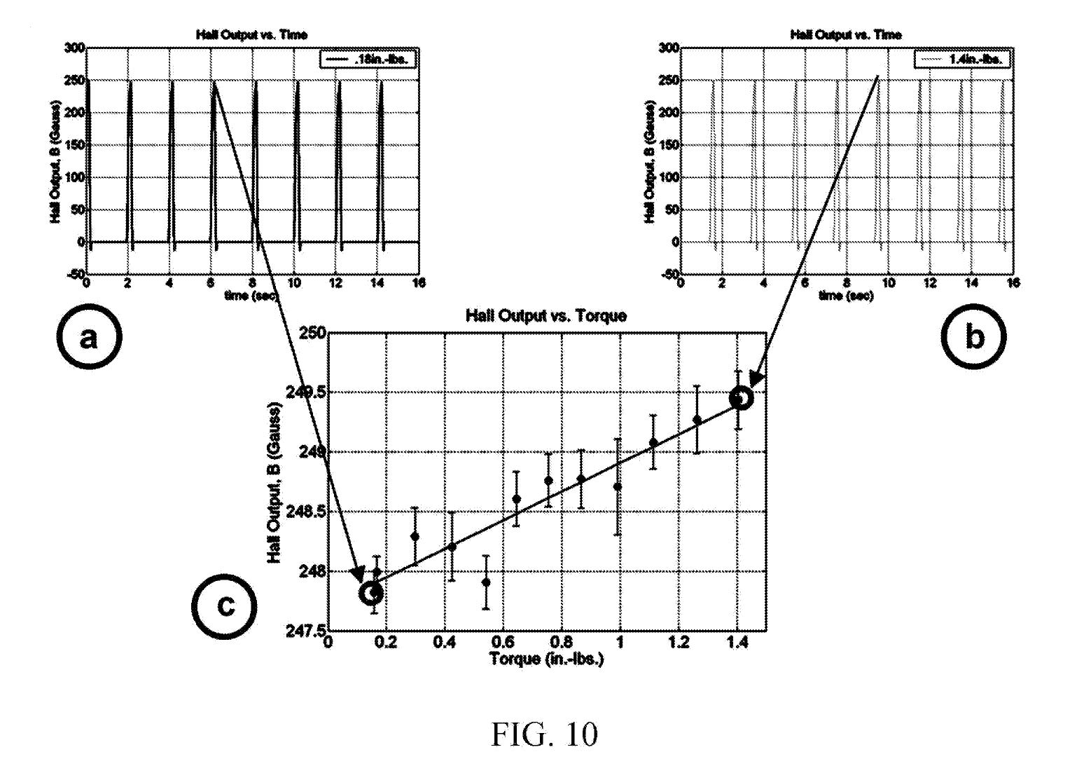

Torque measurement on a rotating shaft was conducted on the above test stand using a Hall sensor. As with the static tests, the Galfenol patch was bonded to the aluminum shaft with <100> direction oriented parallel to 45° direction on the shaft with respect to the shaft axis. The geared motor was set to 30 rpm and increased current is given to the brake motor which causes an increase in torque on the shaft. FIG. 9(A) shows a photo of the test setup. The torque values are measured by the rotational torque sensor and recorded on a signal analyzer. The Hall effect sensor with the bias magnet bonded next to it, as sketched in FIG. 9(B), was suspended approximately 0.04 inch over the region that the Galfenol patch will pass as the patch rotates with the shaft. The output from the Hall effect sensor was recorded simultaneously with the torque from the commercial torque sensor over a period of 16 seconds at a sample rate of 50 Hz. The torque provided by the brake motor was increased and the measurements were recorded again for the new torque value. This was repeated several times for the 30 RPM rotation rate, but with varying levels of torque. Both the average of Hall effect sensor peak outputs, with 95% confidence intervals, and the integral of power spectrum of the 16 second data were then plotted against their corresponding torque value from the commercial torque sensor. FIG. 9(C) shows the Hall sensor output vs. time for the rotational portion of the test. The points where the corners of the Galfenol patch pass under the Hall effect sensor are also visible in FIG. 9(C). The peak values in the data points were found using a program in MATLAB. Within the measurement interval there were 8 peaks which were averaged for each individual torque setting across the measurement interval. The averaged peak output for the Hall effect sensor is plotted for torque values from 0.18 in.-lbs. to 1.4 in.-lbs. as measured from the torque sensor in FIG. 10. A linear trend can be seen for the Hall sensor output vs. torque across the measured torque range. The minimum and maximum torque points are referenced to their respective Hall sensor output vs. time plot. The minimum torque of 0.18 in.-lbs. is represented as the trace in FIG. 10(A) and the maximum torque of 1.4 in.-lbs. is shown as the trace in FIG. 10(B).

Example Magnetic Field Sensors 40

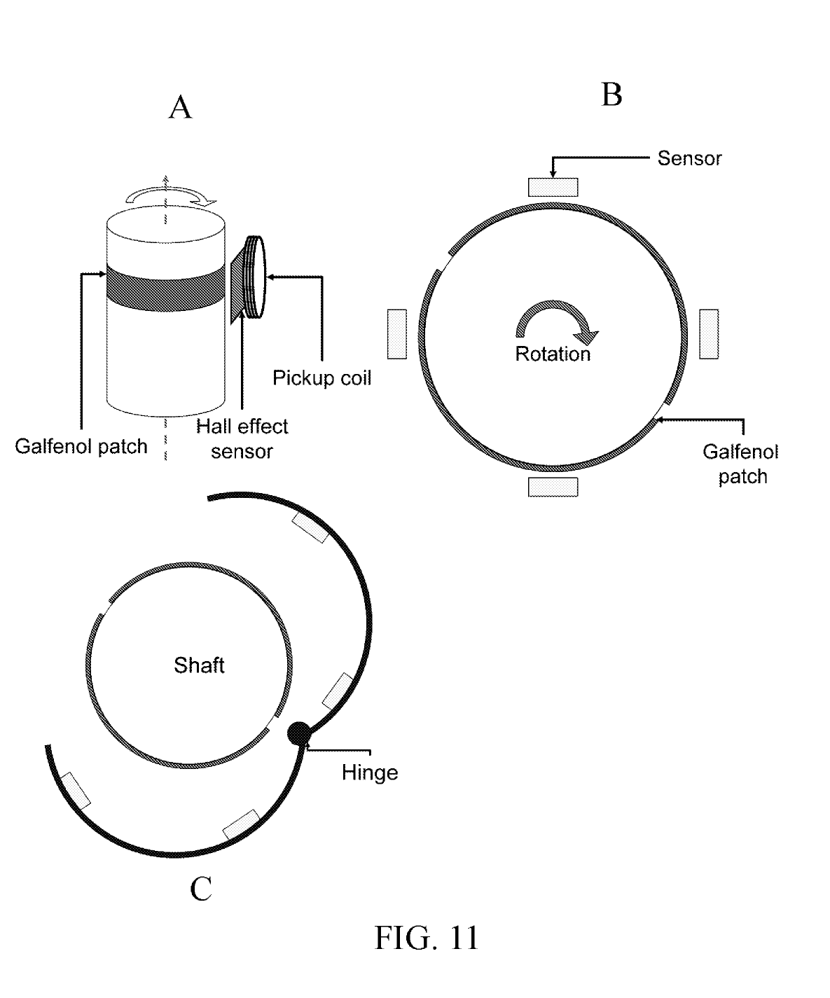

Two options are available for the magnetic field sensor 40 used to monitor the changing magnetic field in the Galfenol patch 30. A Hall effect sensor works to effectively monitor the magnetic field in the material provides information on the torque in the shaft. A pickup coil arrangement works to monitor the change in the magnetic field with time and provides information on the torque rate of change. Table 1 provides a comparison of the sensor types which can be used. Each of these sensor types are mounted in the fixed frame and are able to monitor torque levels in the rotating frame. Hall effect and pick-up coil can be used to monitor the Galfenol patch as it rotates on shaft as shown in FIG. 11(A). Multiple sensors positions around the circumference allow increase the number of sensor signals and can improve signal clarity and remove noise as shown in FIG. 11(B). An additional benefit of such an approach is the ability to decouple torsion, torsion rate, and bending vibration of the shaft. Bending vibration of the shaft is based on lateral deflection of the shaft with respect to the sensor. The magnetic field is dependent on the air gap. The sensor layout incorporated into a clamshell device shown in FIG. 11(C) allows for a retrofit capable system. Additionally, ElectroMagnetic Interference (EMI) shielding measures can be incorporated into the clamshell device.

TABLE 1
Comparison of sensor types

| | Sensor type | |
|---|---|---|
| | Hall effect (or GMR) | |
| Parameter | sensor | Pick-up Coil |
| Physical | Magnetic field (5) | Change in magnetic |
| Measurement | | field (dB/dt) |
| # Measurements | Multiple possible | Multiple possible |
| Application | Shaft torsion levels, | Torque rate of change, |
| | Shaft bending vibration | Shaft bending vibration |

### Example Field Annealing for Magnetic Pre-Biasing

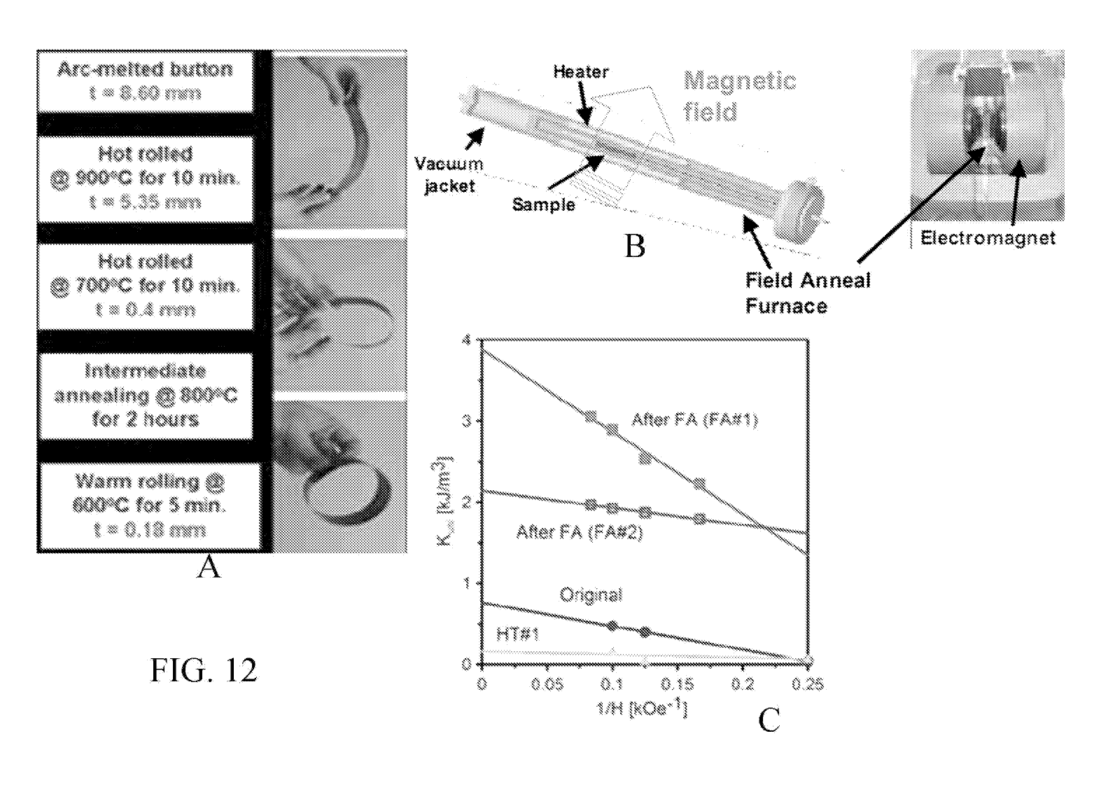

An example fabrication and processing method to align magnetic domains the Galfenol material is herein described to improve sensitivity as a sensor. The first step is the preparation of thin patches from melted buttons of Fe—Ga. The second step involves the magnetic pre-biasing of these thin patches which using magnetic field annealing. The 38-mm-diameter and 7.6-mm-thick melted buttons of polycrystalline Fe—Ga were obtained from a supplier of the raw material. These buttons are doped with suitable elements like Boron, Sulfur or Molybdenum in order to obtain a preferred <100> crystallographic texture which increases the sensitivity of the material and also imparts ductility and malleability which is required for producing very thin sheets by rolling. The sequence of processes used to obtain a 0.3-mm thin sheet starting from the 7.6-mm-thick arc-melted button of doped Galfenol (80.25 at. % Fe+18.7 at. % Ga+1.0 at. % B+0.05 at. % S) is described in Na and Flatau, Secondary recrystallization, crystallographic texture and magnetostriction in rolled Fe-Ga based alloys, American Institute of Physics (2007). During hot rolling, the sample is sealed in a 321 stainless steel can to avoid oxidation and heated between 700-1000° C. for 10 minutes between every 2 passes of rolling. The total reduction is obtained in 82 passes. The warm rolling step involves 53 passes where the sample is heated between 350-600° C. for 10 minutes after every pass. An intermediate annealing step is performed at 800° C. for 2 hours in an inert Argon atmosphere. Finally, during cold rolling, the total reduction is achieved in 18 passes. The sample is subsequently annealed at 1100-1200° C. for 0.5 to 6 hours in Argon or vacuum atmosphere. The sequence of process used to obtain a 0.18-mm thin sheet starting from a 8.6-mm-thick arc-melted button of doped Galfenol (79.3 at. % Fe+18.7 at. % Ga+2.0 at. % Mo) is shown in FIG. 12(A). Once the thin rolled sheets of Galfenol are obtained, they can be cut into required shapes and sizes before performing the magnetic field annealing. Magnetic field annealing on Galfenol involves the exposure of the sample to very high magnetic fields (˜12 kOe) and simultaneous thermal annealing below the Curie temperature of the material.

A schematic of the setup is shown in FIG. 12(B). Galfenol samples of 6.25-mm diameter and 0.4 to 2-mm thick were placed inside a heater enclosed in a vacuum jacket and the whole setup was placed in between the poles of an electromagnet. Torque measurements were performed on each sample to calculate the uniaxial anisotropy constant developed due to the magnetic field annealing along the [100] crystallographic direction of the samples. The uniaxial anisotropy is a measure of the magnetic domain alignment achieved along a preferred direction. Results shown in FIG. 12(C) indicate that field annealing procedures (identified as FA#1 and FA#2) imparted a built-in anisotropy to the samples.

Magnetic Layer Deposition

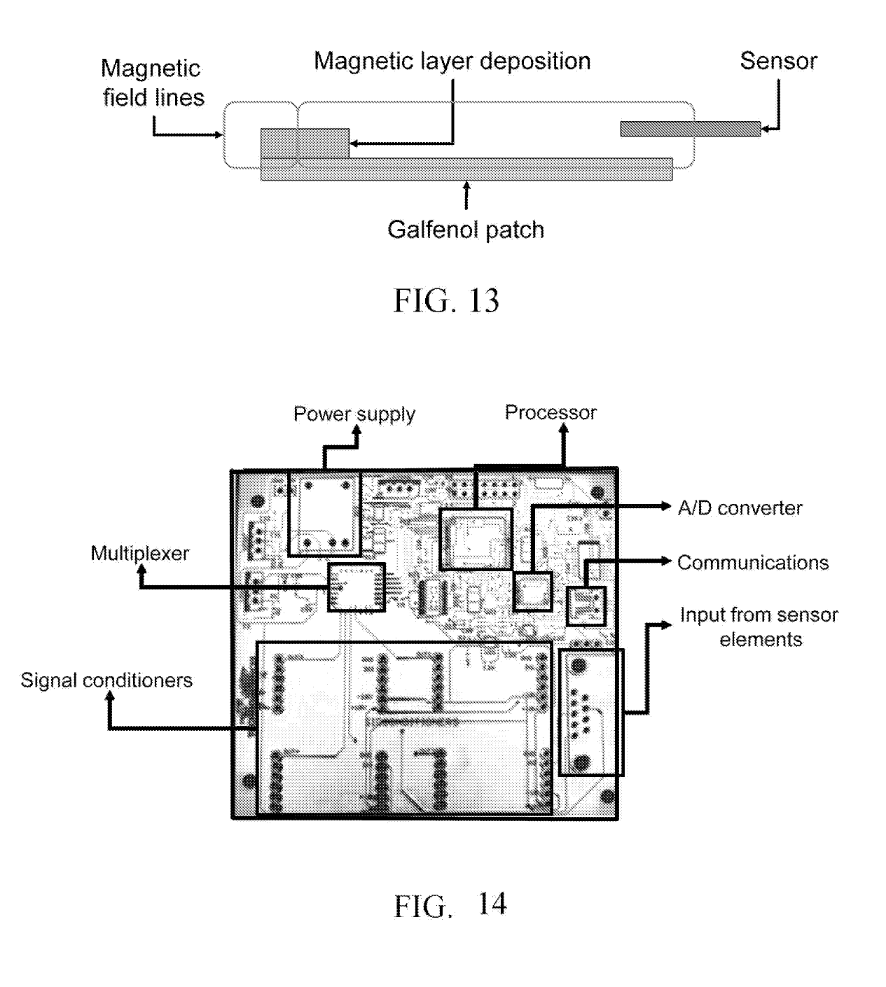

As noted above, discrete permanent biasing magnets may be used to provide the magnetizing field for the Galfenol material. Alternatively, a deposited magnetic layer may also be used as a means of imparting a magnetizing field as shown in FIG. 13.

Example Electronic Hardware

A small form factor programmable controller board with integrated data acquisition and processing suffices to analyze sensor signals, digitize time series data, and run the Vibration/Statistical Analysis Software 700. FIG. 14 illustrates an exemplary programmable controller board layout implementing the block diagram of FIG. 3

Quantitative Results

The NCTS sensor system described herein has a diverse range of applications for both military and civilian purposes. For military applications, the NCTS sensor system can be for machinery/components on naval vessels, ground vehicles, airplanes, and helicopter (both main rotor and tail rotor drive shafts) which all contain machinery with rotating shafts. Similar applications exist in the civilian areas as well.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A sensor for analysis of forces or forces and motion on a rotating shaft without contacting said shaft, comprising:
a magneto-elastic material fixedly applied to the rotating shaft; and
a magnetic field pick up surrounding both said shaft and said magneto-elastic material but not in contact therewith.

2. The sensor according to claim 1, wherein said magneto-elastic material comprises a generally rectangular strip circumscribing said rotating shaft.

3. The sensor according to claim 1, wherein said magneto-elastic material comprises a plurality of sections affixed around said rotating shaft in a radial pattern.

4. The sensor according to claim 2, wherein said rectangular strip has a length equal to a circumference of said rotating shaft.

5. The sensor according to claim 2, wherein said rectangular strip comprises Galfenol.

6. The sensor according to claim 3, wherein said plurality of sections all comprise Galfenol.

7. The sensor according to claim 1, wherein said at least one section of magneto-elastic material is bonded to the rotating shaft.

8. The sensor according to claim 1, wherein said at least one section of magneto-elastic material is thermally fused to the rotating shaft.

9. The sensor according to claim 1, wherein said at least one section of magneto-elastic material is deposited to the rotating shaft.

10. The sensor according to claim 1, wherein said magnetic field sensor comprises a Hall effect sensor.

11. The sensor according to claim 10, wherein said magnetic field pick up comprises a two-section toroidal collar about said shaft and a pickup coil wound about said toroidal collar.

12. The sensor according to claim 1, wherein said magnetic field pick up comprises a giant Magnetoresistance (GMR) sensor.

13. The sensor according to claim 12, wherein said magnetic field pick up comprises a two-section toroidal collar about said shaft and a pickup coil wound about designated sections of the said toroid or on components mounted to said toroid.

14. The sensor according to claim 1, adapted to measure any one or more parameters from among the group consisting of: (1) torque, (2) rate of change of torque, (3) shaft speed, (4) shaft position, (5) bending moments in the shaft in 2 directions, (6) axial load, (7) shaft power and/or system efficiency.

15. The sensor according to claim 1, wherein said magneto-elastic material fixedly applied to the rotating shaft is defined by surface features chosen from among the group consisting of ridges, ribs and indentations.

16. A sensor for analysis of forces or forces and motion on a rotating shaft without contacting said shaft, comprising:
at least one section of magneto-elastic material fixedly applied to the rotating shaft; and
a magnetic field sensor surrounding both said shaft and said magneto-elastic material thereon, but not in contact with either; and
at least one pre-bias permanent magnet mounted proximate said at least one section of magneto-elastic material.

17. The sensor according to claim 16, wherein said at least one section of magneto-elastic material comprises a rectangular strip affixed around said rotating shaft.

18. The sensor according to claim 16, wherein said at least one section of magneto-elastic material comprises a plurality of sections of affixed around said rotating shaft in a radial pattern.

19. The sensor according to claim 17, wherein said rectangular strip has a length equal to a circumference of said rotating shaft.

20. The sensor according to claim 17, wherein said rectangular strip comprises Galfenol.

21. The sensor according to claim 18, wherein said plurality of sections all comprise Galfenol.

22. The sensor according to claim 16, wherein said at least one section of magneto-elastic material is bonded or thermally fused to the rotating shaft.

23. The sensor according to claim 16, wherein said magnetic field sensor comprises a Hall effect sensor.

24. The sensor according to claim 16, wherein said magnetic field sensor comprises a two-section toroidal collar about said shaft and a pickup coil wound about designated sections of the said toroid or on components mounted to said toroid.

25. The sensor according to claim 16, wherein said magnetic field sensor comprises a giant Magnetoresistance (GMR) sensor.

26. The sensor according to claim 16, adapted to measure any one or more parameters from among the group consisting of: (1) torque, (2) rate of change of torque, (3) shaft speed, (4) shaft position, (5) bending moments in the shaft in 2 directions, (6) axial force, (7) shaft power and/or system efficiency.

27. A non-contact sensor system for measuring a parameter of a rotating shaft chosen from among the group consisting of (1) torque, (2) rate of change of torque, (3) shaft speed, (4) shaft position, (5) bending moments in the shaft in 2 directions, (6) axial force, (7) shaft power and/or system efficiency, said non-contact sensor system comprising:
at least one sensor for analysis of forces and motion on a rotating shaft without contacting said shaft, comprising:
at least one non-contact sensor including
a section of magneto-elastic material fixedly applied to the rotating shaft, and
a magnetic field sensor surrounding both said shaft and said magneto-elastic material thereon, but not in contact with either, for outputting an analog sensor signal;
a digital-to-analog converter for converting said analog sensor signal to a digital time series of data;
a computer processor;
a data transfer system for wired or wireless communication;
a mode separation module comprising a plurality of software instructions stored on a non-transitory computer-readable medium for instructing said processor for separating the digital time series data into any one or more of torque, torque rate, bending, axial, shaft rotation, and shaft position components;
a calibration module comprising a plurality of software instructions stored on a non-transitory computer-readable medium for instructing said processor to conduct calibration for forces including torque, torque rate, bending, and axial along with motion including rotation and position;
an analysis module comprising a plurality of software instructions stored on a non-transitory computer-readable medium for instructing said processor to analyze said digital time series forces and motions to the corresponding calibration information;
a software library of classifier profiles for comparison with said analysis to identify the presence of a damage type, location of damage, and extent of damage to said shaft or machines driving the shaft or being driven by the shaft.
